(19) United States
(12) Patent Application Publication
(10) Pub. No.: US 2014/0347734 A1
(43) Pub. Date: Nov. 27, 2014

(54) LIGHT EXTRACTION SUBSTRATE OF ORGANIC EL LIGHTING

(71) Applicant: Panasonic Corporation, Osaka (JP)

(72) Inventors: Nobuyuki KAMIKIHARA, Nara (JP); Toshihiko WADA, Osaka (JP)

(73) Assignee: Panasonic Corporation, Osaka (JP)

(21) Appl. No.: 14/280,904

(22) Filed: May 19, 2014

(30) Foreign Application Priority Data
May 22, 2013 (JP) 2013-108156
Mar. 5, 2014 (JP) 2014-043099

(51) Int. Cl. G02B 5/18

(52) U.S. Cl. CPC G02B 5/18
USPC 359/576

(57) ABSTRACT

A first layer which has a surface including a diffraction grating part having a plurality of fine concavities and convexities and a second layer which is embedded in the diffraction grating part with no space therebetween are formed on a transparent substrate. A recess part having a fixed width is formed on the outer periphery of the first layer. An outer fence part having a fixed width is formed on the outer periphery of the recess part. The second layer is also embedded in the recess part.

### BACKGROUND OF THE INVENTION

The present invention relates to a light extraction substrate of an organic electroluminescence (EL) lighting used for improving the light emission efficiency of the organic EL lighting.

An organic EL lighting is a self-luminous lighting apparatus. The research and development of an organic EL lighting have been actively promoted not only as a light source of various displays, but also as flat lighting application. An organic EL lighting as lighting application is a surface light source which is different from an LED which is a point light source having high directivity, and has advantages that reduction in thickness or weight can be achieved, and the number of components can also be reduced. Further, by using a flexible substrate, there is also a possibility of achieving lighting with a thin curved surface. Therefore, further improvement in the light emission efficiency is desired as realizing practical use thereof approaches.

An organic EL lighting is formed as a surface light emission body by laminating an anode, an organic EL element, and a cathode in this order on the surface of a transparent substrate. However, light emitted from an organic EL element is totally reflected on the interface between adjacent layers havingdifferent refractive indexes andtherefore cannot be fully extracted to the outside. In the current situation, when a general glass substrate is used, the light extraction efficiency is approximately 20% and is therefore extremely low.

FIG. 4 illustrates the configuration of a conventional organic EL lighting substrate on which a light extraction layer is formed. FIG. 4 is a cross-sectional view of a conventional organic EL lighting substrate.

First, a quadrilateral light extraction layer 12 is formed on a quadrilateral glass substrate 11, and an anode 13, an organic EL element 14, and a cathode 15 are laminated thereon in this order. Further, a sealing part 16 which seals the organic EL element 14 is provided above an electrode extraction part of the anode 13 and the cathode 15. By applying a voltage between the anode 13 and the cathode 15, the organic EL element 14 emits light. The emitted light passes through the light extraction layer 12 and the glass substrate 11, and is released to the outside from a surface of the glass substrate 11, the surface being located opposite to the sealing part 16. Total reflection of light caused by a difference in refraction index that occurs in the interface of the glass substrate 11 on the side of the sealing part and the interface thereof on the side of the light releasing surface can be suppressed by providing the light extraction layer 12 which has a refractive index different from the refractive index of the organic EL element 14 or the glass substrate 11 so as to to be interposed between the organic EL element 14 and the glass substrate 11, thereby improving the light extraction efficiency.

Further, as a technique for improving the light extraction efficiency, there have been proposed structures such as a structure in which a high refractive lens is provided on the surface of the glass substrate 11, a structure in which a micro lens is arranged on a region of the light extraction layer 12 (see Patent Literature 1, for example), and a structure in which a diffraction grating part is placed. In all of these structures, although improvement in the efficiency can be expected, reduction in cost and thickness is difficult. Further, there has been proposed a structure in which concave-convex processing is performed on the organic EL element 14 itself. However, such a structure becomes complicated, and therefore lacks practicality when taking an actual manufacturing technique or cost into consideration. Further, as a relatively simple conventional method, there is a method for reducing light that is totally reflected and thereby attenuated inside the apparatus by forming a light diffusion layer which contains scattering members or beads having different refractive indexes in a region of the light extraction layer 12, or by sticking a film which contains the above materials onto the surface of the glass substrate 11 (see Patent Literature 2, for example). However, the light extraction efficiency achieved by these proposals is still not sufficient, and further improvement is therefore desired.

Therefore, the inventors of this application have designed a diffraction grating part shape having a pattern that enables light to be efficiently extracted by analyzing the emission pattern of light that enters a light extraction layer 12 from an organic EL element 14 using an optical analysis technique and a light extraction layer 12 which has a two-layer structure in which an upper layer and a lower layer have different refractive indexes, and the practical application thereof is currently earnestly under consideration (herein below, a substrate in which the light extraction layer 12 is laminated on the glass substrate 11 is referred to as a light extraction substrate).

FIGS. 5A and 5B illustrate the configuration of the light extraction substrate. FIG. 5A is a perspective view of the light extraction substrate and the FIG. 5B is a cross-sectional view thereof. As illustrated in FIG. 5B, a first layer 32 is formed on a quadrilateral glass substrate 11. The first layer 32 is provided with a concave-convex portion 34 which has a unique shape obtained by a wave optical analysis and formed of a material having a refractive index that is close to the refractive index of the glass substrate 11. Further, a second layer 33 is formed on the concave-convex portion 34. The second layer 33 has a function of being embed therein concavities and convexities on the surface of the concave-convex portion 34 so as to be flattened and is formed of a material having a refractive index that is close to the refractive index of the organic EL element 14 as a light emission layer.

In order to achieve a light extraction substrate having the configuration as illustrated in FIGS. 5A and 5B at low cost, formation of the second layer 33 by applying a relatively low-cost resin material is under consideration.

### CITATION LIST

### Patent Literature

[Patent Literature 1] Japanese Unexamined Patent Publication No. 2010-157421

[Patent Literature 2] Japanese Unexamined Patent Publication No. 2011-248104

### SUMMARY OF THE INVENTION

However, in a light extraction substrate having the configuration as illustrated in FIGS. 5A and 5B, when a usual application method is used, swelling 33a is likely to occur on an end of the second layer 33 as illustrated in FIG. 6, and it is therefore difficult to flatten the second layer 33. When the swelling 33a occurs and the thickness of the second layer 33 thereby partially increases, a region in which the light transmittance decreases is generated. As a result, the light extraction efficiency is reduced. In addition, there is also the risk of disconnection of an anode which is laminated on the second layer 33 or a decrease in the amount of light emitted from an organic EL element. If the region in which the swelling 33a occurs in the second layer 33 is designed as being outside an effective range of a light emission area in order to prevent the above problem, a frame part around a panel, the frame part not emitting light, will be made larger. In view of development as display application, reduction in the frame part, namely, fame narrowing and cost reduction are required issues.

Further, the flow of liquid on an application end is likely to change due to the influence of the viscosity of the applied liquid itself or the wettability with the substrate. Therefore, it is extremely difficult to improve the application width accuracy of the second layer 33 having a quadrilateral pattern. Further, since the film thickness on the application end gradually decreases, it is necessary to apply the second layer 33 so as to be at least wider than the light emission area of the first layer 32. As a measure for the above, removal of a width fluctuation portion and a thin film portion after applying the second layer 33 so as to be slightly wide is conceivable. However, in such a method, the number of steps increases. In addition, a measure against material loss and dust generated at the time of the removal is also required, which results in an increase in cost. Therefore, in order to achieve a light extraction substrate having the configuration as illustrated in FIGS. 5A and 5B by application, the second layer 33 is required to be applied wider than necessary. Therefore, not only frame narrowing, but also cost reduction becomes difficult.

It is an object of the present invention to provide a light extraction substrate of an organic EL lighting capable of achieving the organic EL lighting having high light emission efficiency and capable of achieving frame narrowing.

In accomplishing these and other aspects, according to an aspect of the present invention, there is provided a light extraction substrate of an organic EL lighting comprising:

a transparent substrate;

a first layer formed on the substrate, the first layer having a surface including a diffraction grating part having a plurality of fine concavities and convexities;

a second layer formed on the transparent substrate so as to be embedded in the diffraction grating part with no space therebetween;

a recess part having a fixed width, the recess part being formed on an outer periphery of the first layer; and

an outer fence part having a fixed width, the outer fence part being formed on an outer periphery of the recess part,

wherein the second layer is embedded in the recess part.

As described above, by using the light extraction substrate of the organic EL lighting according to the aspect of the present invention, it is possible to provide an organic EL lighting which has high light emission efficiency and is capable of achieving frame narrowing.

### BRIEF DESCRIPTION OF THE DRAWINGS

These and other aspects and features of the present invention will become clear from the following description taken in conjunction with the embodiments thereof with reference to the accompanying drawings, in which:

FIG. 1 is a view illustrating the structure of an organic EL lighting substrate in an embodiment of the present invention.

FIG. 2A is a perspective view illustrating the structure of a light extraction substrate in the embodiment of the present invention.

FIG. 2B is a cross-sectional view illustrating the structure of the light extraction substrate in the embodiment of the present invention.

FIG. 3 is a view illustrating a method for manufacturing the light extraction substrate in the embodiment of the present invention.

FIG. 4 is a view illustrating the structure of a conventional organic EL lighting substrate described in Patent Literature 1.

FIG. 5A is a perspective view illustrating the structure of a conventional light extraction substrate.

FIG. 5B is a cross-sectional view illustrating the structure of the conventional light extraction substrate.

FIG. 6 is a view illustrating a state where swelling occurs on an end in the conventional light extraction substrate.

FIG. 7A is a perspective view illustrating the fact that the width of a recess part is equal in two sides facing each other and different in two sides perpendicular to each other in the light extraction substrate of the embodiment of the present invention.

FIG. 7B is a plan view illustrating the fact that the width of the recess part is equal in two sides facing each other and different in two sides perpendicular to each other in the light extraction substrate of the embodiment of the present invention.

FIG. 8 is a partially enlarged cross-sectional view illustrating an example in which a diffraction grating part and an outer fence part are divided from each other in the light extraction substrate of the embodiment of the present invention.

### DESCRIPTION OF THE EMBODIMENTS

Note that the same components will be denoted by the same reference numerals throughout the accompanying drawings.

Herein below, an embodiment of the present invention will be described with reference to the drawings.

First, the configuration of an organic electroluminescence (EL) lighting substrate 40 according to an embodiment of the present invention will be described.

FIG. 1 is a view illustrating the structure of the organic EL lighting substrate 40 in the embodiment of the present invention.

In FIG. 1, X1 denotes the dimension of an area that is located outside an effective range of a light emission area 41, and the area of the dimension X1 serves as a frame part of an organic EL lighting panel. In the present embodiment, the area of the dimension X1 is referred to as a frame part 42.

The organic EL lighting substrate 40 of the present embodiment is formed by laminating a low refractive layer (low refractive index layer) 2 which is a light extraction layer and functions as an example of a first layer and a high refractive layer (high refractive index layer) 3 which is a light extraction layer and functions as an example of a second layer in this order on a transparent substrate 1. Further, on the top of that, an anode 13 having translucency, an organic EL element 14, and a cathode 15 are laminated in this order. Further, a sealing part 16 which seals the organic EL element 14 is provided above an electrode extraction part of the anode 13 and the cathode 15. The transparent substrate 1, the low refractive layer 2, and the high refractive layer 3 constitute a light extraction substrate 43.

In each of the drawings, cross section hatching for the high refractive layer 3 is omitted for the purpose of clearly illustrating the configuration of the low refractive layer 2.

Next, the configuration of the light extraction substrate 43 will be more specifically described.

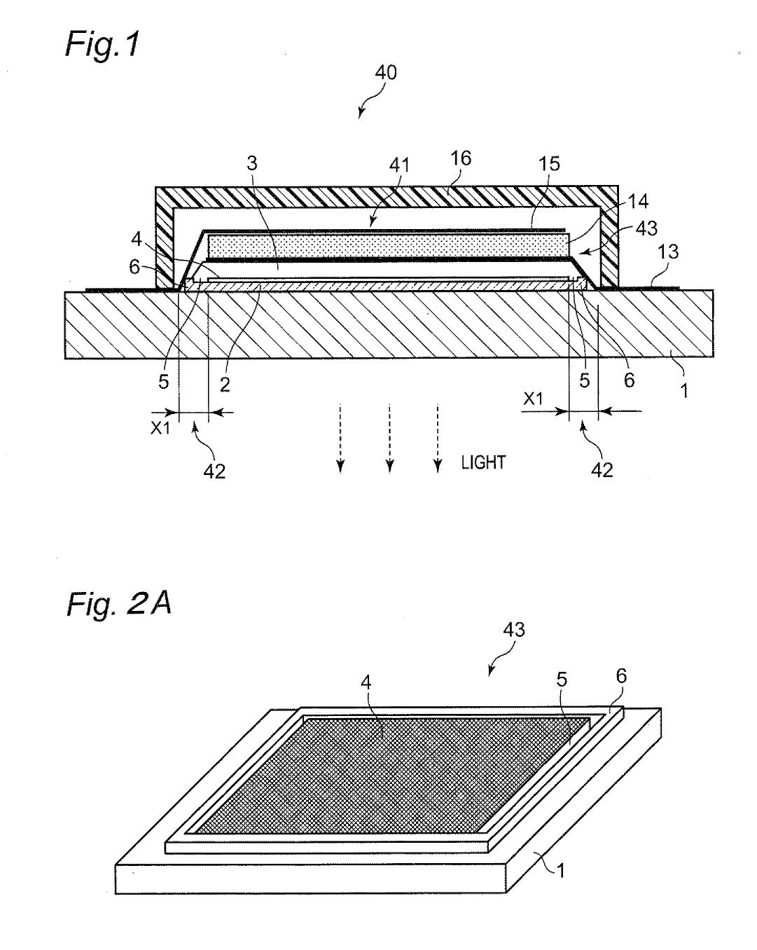

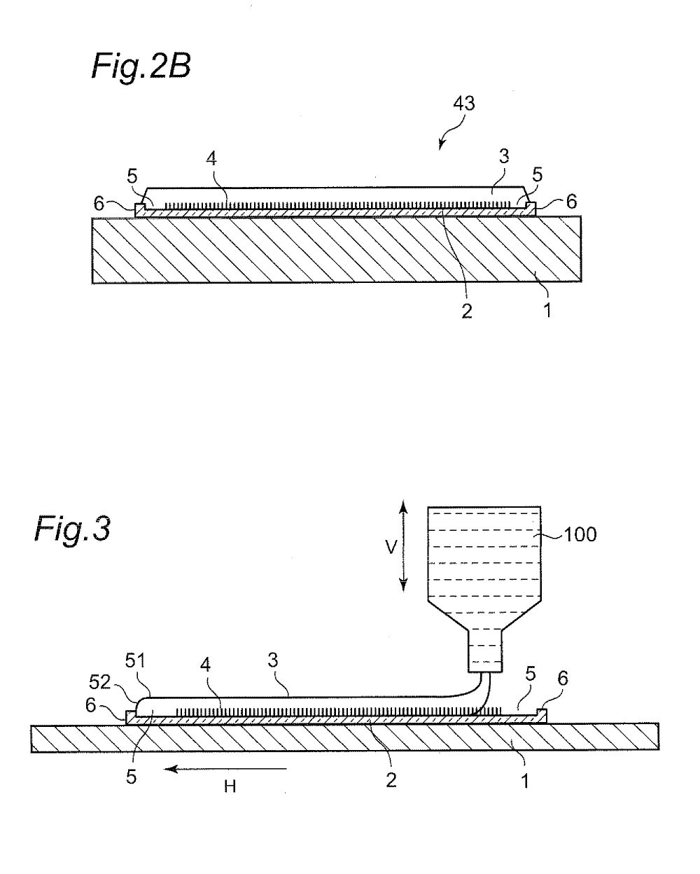

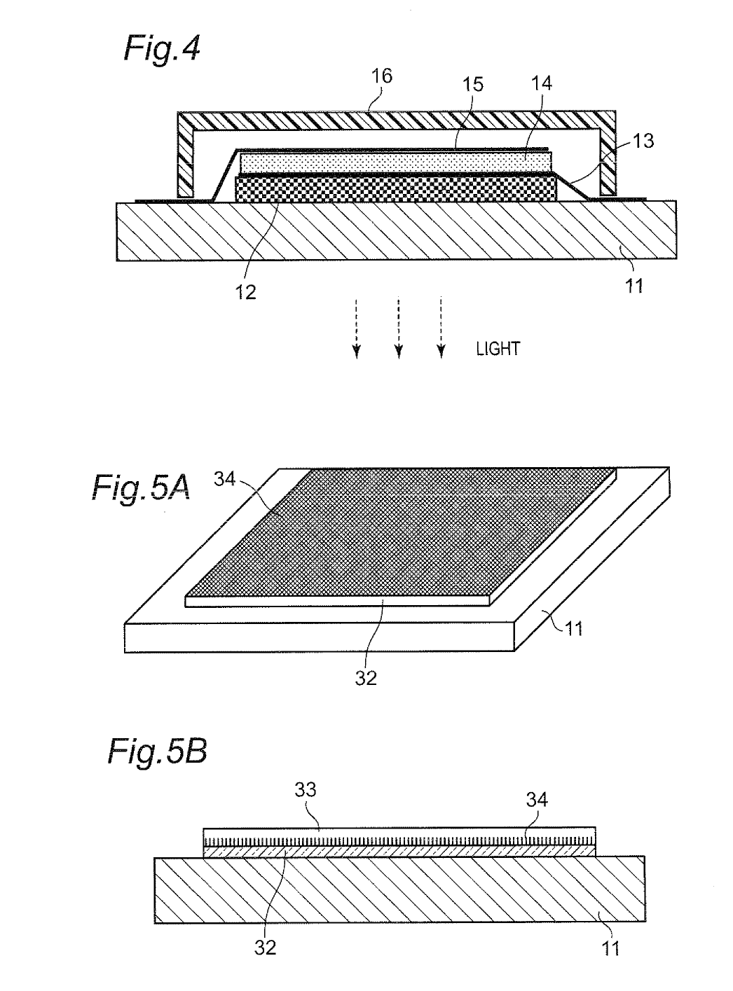

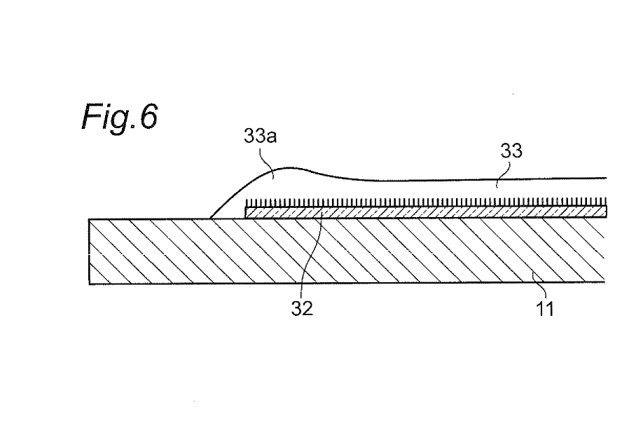

FIGS. 2A and 2B are views illustrating the structure of the light extraction substrate 43 of the present embodiment.

In FIGS. 2A and 2B, the low refractive layer 2 includes a diffraction grating part 4 which is formed in a quadrilateral area, a recess part 5 which is formed into a quadrilateral frame-like groove on the outer periphery of the diffraction grating part 4 and has a fixed width, and an outer fence part (outer convex portion) 6 which is formed into a quadrilateral frame protruding upward on the outer periphery of the recess part 5 and has a fixed width. The high refractive layer 3 is arranged so as to be embedded in the diffraction grating part 4 of the low refractive layer 2 with no space therebetween, and also arranged on the recess part 5 and the outer fence part 6. The high refractive layer 3 is embedded up to the upper surface of the recess part 5 of the low refractive layer 2. The light emission area 41 of the organic EL lighting substrate 40 is an area (not illustrated) that is located on the inner side by a predetermined width with respect to the outer periphery of the diffraction grating part 4. The upper surface of the outer fence part 6 preferably does not protrude above the upper surface of the high refractive layer 3.

Therefore, the low refractive layer 2 is constructed by the diffraction grating part 4, the recess part 5, and the outer fence part 6, and is basically composed of a photo-curable resin or the like as a single member. However, the present invention is not limited thereto, and only the outer fence part 6 may be composed of a separate porous member as described later.

Further, the outer fence part 6 of the low refractive layer 2 is porous. The low refractive layer 2 is composed of a photo-curable resin. The surface of the high refractive layer 3 is made flat. These configurations will be specifically described below.

Next, the operation of the organic EL lighting substrate 40 of the present embodiment will be described.

As illustrated in FIG. 1, by applying a voltage between the anode 13 and the cathode 15, the organic EL element 14 emits light. The emitted light passes through the anode 13 having translucency, and enters the high refractive layer 3. Inside the high refractive layer 3 which has a refractive index that is close to the refractive index of the organic EL element 14 as a light emission layer, the light is hardly reflected and emitted to the low refractive layer 2. The light is diffused on the interface between the high refractive layer 3 and the low refractive layer 2. Even a portion of light that has entered the low refractive layer 2 at an angle allowing the light to be reflected inside the low refractive layer 2 which has a refractive index close to the refractive index of the transparent substrate 1 on the light releasing side is not reflected inside the low refractive layer 2, but passes through the low refractive layer 2. An interface shape that is derived from diffusion pattern calculation by an optical analysis and most efficiently allows light to pass therethrough is formed on the interface between the high refractive layer 3 and the low refractive layer 2 at the side of the low refractive layer 2. Then, the light passes through the low refractive layer 2 and the transparent substrate 1, and is released from the surface of the transparent substrate 1, the surface being located opposite to the sealing part 16.

Next, a method for manufacturing the light extraction substrate 43 will be described. Herein below, the description will be made by showing a concrete example.

As the material of the transparent substrate 1, a glass substrate having translucency such as non-alkali glass or a resin substrate having translucency and heat resistance such as a PET film is used. The surface of the transparent substrate 1 is cleaned by dry cleaning such as O₂ ashing and UV irradiation or wet cleaning using pure water containing an organic solvent or a surfactant.

Then, an adhesive (not illustrated) such as a silane coupling agent is applied onto the transparent substrate 1 with a spin coater, spray, or the like, and dried. A high polymer material which is easily coupled to the low refractive layer 2 or the transparent substrate 1 is used.

As the material of the low refractive layer 2, not only an organic material whose main component is a photo-curable resin or the like (described below), but also an inorganic material whose main component is bismuth oxide or the like is used. When using such a material, ink that is mixed with any type of solvent is applied with a spin coater or the like, and the solvent contained in the ink is then removed. After that, the material is molded in a desired shape (nanoinprint in the present embodiment).

The low refractive layer 2 is formed by pressing a mold which has an inverted shape of the diffraction grating part 4 and the recess part 5 against a film from which the solvent is removed, then curing the film, and then removing the mold therefrom. A pressing surface of the mold is previously subjected to release treatment.

FIG. 3 is a view illustrating a method for manufacturing the light extraction substrate 43. As the material of the high refractive layer 3, an organic material whose main component is a thermosetting resin is used. As with the low refractive layer 2, as illustrated in FIG. 3, ink that is mixed with any type of solvent is sucked out from the inside of a nozzle 100 by a capillary phenomenon to thereby apply the ink onto the surface of the low refractive layer 2. At this time, the nozzle 100 moves up and down in a direction indicated by arrow V while the nozzle 100 allows to run in a direction indicated by arrow H in the lateral direction over the transparent substrate 1 on which the low refractive layer 2 is formed. The application starting position is adjusted so that a high refractive layer end 52 is located on the inner side of the recess part 5. A method for applying the high refractive layer 3 is desirably a capillary coating method described in the present embodiment. However, a pattern printing method such as screen printing and offset printing, die coating, and the like may also be selected.

In such a configuration, swelling on the outer peripheral part of the high refractive layer 3 is absorbed in the recess part 5. Therefore, a high refractive layer outer peripheral part 51 can be flattened. As a result, a phenomenon of the generation of a region in which the light transmittance decreases, or a quality problem such as disconnection of the anode 13 and a decrease in the amount of light emitted from the organic EL element 14 can be solved. Further, the area of the frame part 42 around the panel, the frame part 42 not emitting light, is prevented from increasing. Therefore, frame narrowing can be achieved. Further, since such a configuration can be achieved by applying a low-cost organic material, cost reduction can also be achieved.

Next, the feature and effect of the present embodiment will be described.

A first feature of the present embodiment is that the recess part 5 and the outer fence part 6 are added on the outer periphery of the diffraction grating part 4 to form a dam structure so that the outer fence part 6 has a dam-like function of preventing ink of the high refractive layer 3 from flowing to the outside of the recess part 5.

As described above, the recess part 5 is formed on the outer periphery of the diffraction grating part 4 of the low refractive layer 2 for the purpose of suppressing swelling on the outer peripheral part of the high refractive layer 3 which is applied onto the upper surface of the low refractive layer 2. However, the volume of this uneven thickness part is likely to fluctuate due to the influence of the physical property of the ink of the high refractive layer 3 or the wettability with the low refractive layer 2. Therefore, when the volume of the recess part 5 is not enough to receive the ink, the ink flows out of the recess part 5 and the application width of the ink thereby disadvantageously expands. In other words, a region other than the light emission area 41 expands, which hinders frame narrowing.

Therefore, in the present embodiment, the outer fence part 6 is provided on the outer periphery of the recess part 5 to thereby form a dam structure. More specifically, by providing the outer fence part 6, even when the ink cannot be sufficiently received in the recess part 5, the outer fence part 6 serves as a breakwater to prevent the ink of the refractive layer 3 from flowing to the outside of the recess part 5. As a result, the outer fence part 6 can prevent the application width of the ink from expanding.

Therefore, the first feature of the present embodiment, that is, the provision of the outer fence part 6 on the outer periphery of the recess part 5 can suppress swelling on the outer peripheral part of the high refractive layer 3, and also achieve frame narrowing.

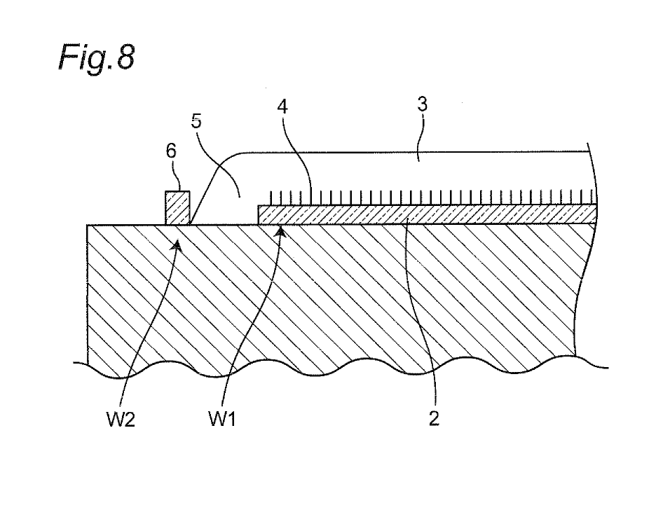

On the other hand, as a method for forming such a dam structure, a flat plate press imprint method is conceivable. However, in the imprint method, when a mold on which a concave-convex shape as a fine pattern is formed is pressed into a resin layer before being cured, a thin film is inescapably left due to a reaction force caused by the viscoelasticity of the resin film even when the thickness of the resin film is thinner than the difference in level in the concave-convex shape. Therefore, when the diffraction grating part 4 and the outer fence part 6 are integrally formed using the same material, a remaining film is formed also on the recess part 5 which does not require a thin film thereon. Therefore, as illustrated in FIG. 1, the diffraction grating part 4 and the outer fence part 6 are connected to each other. It is also possible to divide the diffraction grating part 4 and the outer fence part 6 from each other so as not to be connected through a film by forming the diffraction grating part 4 and the outer fence part 6 using different materials, or by separately performing a forming step of the diffraction grazing part 4 and a forming step of the outer fence part 6 in two stages even when the same material is used as a measure for preventing the formation of the remaining film (see FIG. 8). In the present embodiment, since the refractive index of the first layer 2 which includes the diffraction grating part 4, the recess part 5, and the outer fence part 6 and the refractive index of the transparent substrate 1 are substantially equal to each other, both of the above cases are possible. When diffraction grating part 4 and the outer fence part 6 are divided from each other, by forming the diffraction grating part 4 and the outer fence part 6 using different materials, the wettability can be reduced in the diffraction grating part 4 (see W1 of FIG. 8) so as to be wet, and, on the other hand, the wettability can be enhanced in the outer fence part 6 (see W2 of FIG. 8) so as to repel the material of the high refractive layer 3. Therefore, it is possible to adjust each of the wettability of the diffraction grating part 4 and the wettability of the outer fence part 6 to an appropriate wettability. This is effective, for example, when the material of the high refractive layer 3 is likely to wet-spread in the application thereof.

On the other hand, the three members, namely, the diffraction grating part 4, the recess part 5, and the outer fence part 6 may also be formed using the same material. In this case, the wettability becomes constant in the three members, which is effective when the material of the high refractive layer 3 is not likely to wet-spread. In addition, the three members can be formed by a single step. Therefore, it is possible to reduce the number of steps, and improve the quality.

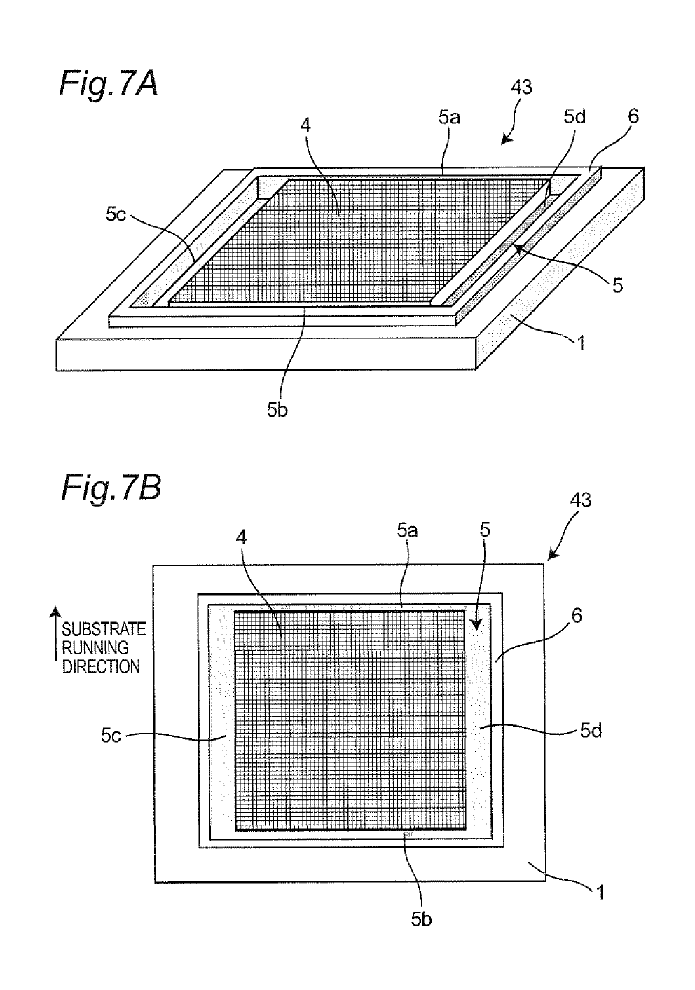

Further, when a capillary coating method as illustrated in FIG. 3 or a die coating method is used as a method for applying the high refractive layer 3, swelling on an application starting end and an application finishing end in the running direction of the transparent substrate 1 can be prevented by adjusting a space between the nozzle 100 and the transparent substrate 1, or the amount or the pressure of ink to be supplied. Therefore, the width of a portion of the recess part 5 (5a 5b) corresponding to these positions can be reduced. However, since both ends in the nozzle width direction perpendicular thereto cannot be adjusted, the width of a portion of the recess part 5 (5c, 5d) corresponding to these positions cannot be reduced. Therefore, as illustrated in FIGS. 7A and 7B, in the width dimensions of the recess parts 5a, 5b on two sides corresponding to the ends in the substrate running direction and the width dimensions of the recess parts 5c, 5d on two sides corresponding to the ends in the nozzle width direction, it is desirable that the width dimensions of two sides that face each other (5a and 5b, or 5c and 5d) are equal to each other, but the width dimensions of two sides that are perpendicular to each other (5a and 5c, 5a and 5d, 5b and 5c, or 5b and 5d) are different from each other. This is because of that such a configuration makes it possible to make the embedded amount of the high refractive layer 3 into the four recess parts 5a to 5d uniform, thereby improving the flatness.

Further, the outer fence part 6 may be made thicker than the diffraction grating part 4 in order to reliably dam the ink of the high refractive layer 3. However, since the vicinity of the outer fence part 6 swells if the outer fence part 6 is made thicker than the surface of the high refractive layer 3, the height of the outer fence part 6 is desirably equal to or higher than the height of the diffraction grating part 4 as well as lower than the surface of the high refractive layer 3.

A second feature of the present embodiment is that the surface of the high refractive layer 3 is flat.

The flatness of the surface of the high refractive layer 3 depends on concavities and convexities of the diffraction grating part 4 of the low refractive layer 2 as a base. When the flatness is poor, the anode 13 which is laminated on the high refractive layer 3 is bent. When the anode 13 is bent in this manner, there is the risk of disconnection of the anode 13. In addition, since the organic EL element 14 which is laminated on the anode 13 includes a plurality of layers in 0.01 urn, there is also a risk that the organic EL element 14 may be partially missing, and the light emission amount thereof may thereby significantly decrease.

Therefore, in the present embodiment, in order to make the surface of the high refractive layer 3 flat, the thickness of a film that can be formed with a roughness of 0.01 μm or less has been obtained through experiment. As a result, it has been revealed that the film thickness is required to be twice or more of the difference in height of the concavities and convexities in the diffraction grating part 4. However, when the thickness of the high refractive layer 3 is five times or more of the difference in height of the concavities and convexities in the diffraction grating part 4, the light transmittance significantly decreases. Therefore, in order to make the surface of the high refractive layer 3 flat, the film thickness thereof is desirably two to four times of the difference in height of the concavities and convexities in the diffraction grating part 4.

Therefore, the second feature of the present embodiment, that is, flattening of the surface of the high refractive layer 3 makes it possible to obtain the light extraction substrate 43 having high quality.

A third feature of the present embodiment is that the low refractive layer 2 is composed of a photo-curable resin.

The diffraction grating part 4 of the low refractive layer 2 is formed so that the surface thereof includes a plurality of fine concavities and convexities of, for example, 1 μm or less. The shape accuracy thereof has a large influence on a diffusion pattern of light. Therefore, when the material of the low refractive layer 2 is an inorganic material such as a silicon wafer, the diffraction grating part 4 is generally formed by exposure and development processes by photolithography used for patterning a semiconductor element. However, a development process by wet etching requires much time and cost.

Therefore, the diffraction grating part 4 of the low refractive layer 2 is formed by nanoimprint using a low-cost photo-curable resin. A problem in achieving mass production by nanoimprint is cost reduction in a large-area mold. However, there has been developed a technique for directly embodying an original plate of a large-area mold from an original plate of a quartz mold using a unique method achieved by nanoimprint, and the technique is ready for practical use.

Therefore, the third feature of the present embodiment, that is, the low refractive layer 2 composed of a photo-curable resin makes it possible to reduce the cost of the light extraction substrate 43.

A fourth feature of the present embodiment is that the outer fence part 6 is made porous.

In the present embodiment, it is necessary to apply ink of the refractive layer 3 onto the recess part 5 as thin as possible. Therefore, ink containing a large amount of solvent such as an organic solvent is selected. Only a thermosetting resin which is a solid content after the solvent contained in the ink volatilizes finally remains in the recess part 5. However, ink immediately after being applied contains a large amount of excessive solvent. Therefore, during volatilization of the solvent, there is generated a region in which the solid content is dried before being fixed onto a bottom surface or a wall surface of the recess part 5. As a result, air bubbles remain in the solid content in the outer peripheral part of the high refractive layer 3. The air bubbles cause a decrease in the refractive index. Therefore, a region in which the refractive index is low is generated in the outer peripheral part of the high refractive layer 3.

Therefore, by making only the outer fence part 6 porous, it is possible to allow only the solvent contained in the material of the high refractive layer 3 to be impregnated into pores of the outer fence part 6 and thereafter volatilize. At this time, basically, the solvent volatilizes from the side surface of the outer fence part 6. However, the solvent volatilizes also from the upper surface of the outer fence part 6, the upper surface not being covered by the high refractive layer 3. It is important not to allow the solvent to remain in the recess part 5 in this manner. By virtue of such an action, the air bubbles in the outer peripheral part of the high refractive layer 3 disappear and the region in which the refractive index is low is reduced.

Therefore, the forth feature of the present embodiment, that is, the porous outer fence part 6 makes it possible to obtain the light extraction substrate 43 having high quality.

A light extraction substrate 43 having a configuration in a working example of the present embodiment and a light extraction substrate having a configuration in prior art were manufactured, and comparison of the application width and the swelling amount in the end film thickness after applying a high refractive layer was made between these light extraction substrates. Next, a result of the comparison will be described below.

### Example 1

First, a non-alkali glass having a length of 120 mm, a width of 120 mm, and a thickness of 0.7 mm to be used as a transparent substrate 1 is dry-cleaned by O₂ ashing. Then, a silane coupling agent diluted with ethanol is applied onto a surface on one side of the non-alkali glass as the transparent substrate 1 using a spin coater at a rotation speed of 1000 rpm for 20 sec, and then dried using an oven at a temperature of 80° C. for 30 min. Then, a UV resin as the material of a low refractive layer 2 is applied onto the surface on which the silane coupling agent is formed, using a spin coater at a rotation speed of 1500 rpm for 30 sec, and a solvent is removed therefrom using an oven at a temperature of 100° C. for 20 min. The UV resin is prepared for thin film application. In the UV resin, the solid concentration is 20 to 60%, the solvent is cyclohexanone, and the viscosity is approximately 10 mPa·s. The thickness of the low refractive layer 2 is 2 μm.

Then, a fluorine resin-based film mold having any shape on which a plurality of convexities and concavities each having a width of 0.8 μm and a depth of 1.2 μm are formed is prepared. The convex-concave surface of the film mold is overlapped, at a predetermined position, with the glass transparent substrate 1 on which the UV resin layer is formed from above. Further, a glass substrate for light shielding mask on which a square exposure portion one side length of which is 100 mm is formed is overlapped with a back surface of the glass transparent substrate 1. Then, pressing is performed using a flat plate press imprint apparatus with a load of 450 N for 60 sec. Then, UV light of an integrated exposure amount of 1000 mJ/cm² is applied from the lower surface. A light shielding portion having a width of 0.5 mm is formed on the outer periphery of the square exposure portion one side length of which is 100 mm of the light shielding mask, and another exposure portion having a width of 0.1 turn is formed on the outer periphery of the light shielding portion. On the surface of the UV resin layer after the imprint, a cured diffraction grating part 4 is formed. A recess part 5 having a width of 0.5 mm is formed on the outer periphery of the diffraction grating part 4, and an outer fence part 6 having a width of 0.1 mm is formed on the outer periphery of the recess part 5.

Then, the glass transparent substrate 1 on which the UV resin is formed and the film mold are taken out of the imprint apparatus, and the film mold is peeled off. Thereafter, an uncured resin is washed away with isopropyl alcohol (IPA), and additional drying is performed at a temperature of 150° C. for 30 min, so that the low refractive layer 2 is formed.

Then, a high refractive layer 3 is applied onto the glass transparent substrate 1 on which the low refractive layer 2 is formed, using a capillary coater of a type illustrated in FIG. 3 at a speed of 10 mm/sec and with a gap of 0.2 mm. Then, the applied high refractive layer 3 is dried and cured using an oven at a temperature of 200° C. for 30 min, so that the high refractive layer 3 is formed on the glass transparent substrate 1 on which the low refractive layer 2 having the recess part 5 and the outer fence part 6 is formed as described in the above embodiment. A thermosetting resin which is a main component of the high refractive layer 3 is prepared for thin film application. In the thermosetting resin, the solid concentration is 10 to 40%, the solvent is cyclohexanone, and the viscosity is approximately 4 mPa·s. The film thickness of the high refractive layer alone is 3 μm.

### Comparative Example 1

First, a low refractive layer is manufactured using the same glass substrate, the same silane coupling agent, and the same UV resin as used in the working example 1 under the same condition as in the working example 1. However, only a square exposure portion one side length of which is 100 mm is formed in a light shielding mask, and only a diffraction grating part is left in the low refractive layer after an uncured resin is removed therefrom after imprint.

Then, the same thermosetting resin as used in the example 1 is applied onto the glass substrate on which the low refractive layer having only the diffraction grating part is formed under the same condition as in the working example 1. Further, the applied thermosetting resin is dried and cured under the same condition as in the working example 1, so that a high refractive layer is formed on the glass substrate on which the low refractive layer having only the diffraction grating part is formed.

### Comparative Example 2

The same thermosetting resin as used in the working example 1 is applied onto the same glass substrate as used in the working example 1 under the same condition as in the working example 1 Further, the applied thermosetting resin is dried and cured under the same condition as in the working example 1, so that only a high refractive layer is formed on the glass substrate.

The application width in each of the light extraction substrates manufactured in the working example 1 and the comparative example 1 and the dummy substrate manufactured in the comparative example 2 was measured using a tool microscope, and the swelling amount in the end film thickness thereof was measured using a laser microscope. A result of comparison using 50 samples in each of the working example and the comparative examples will be shown in Table 1.

TABLE 1

| | | | | | | END |
|---|---|---|---|---|---|---|
| | | | | | | SWELLING |
| | APPLICATION WIDTH | | | | | AMOUNT |
| | UNIT: mm | | | | | UNIT: μm |
| | MAXIMUM | MINIMUM | AVERAGE | P-V | 3σ | AVERAGE |
| WORKING | 100.2 | 100.09 | 100.14 | 0.11 | 0.09 | 0.15 |
| EXAMPLE 1 | | | | | | |
| COMPARATIVE | 100.35 | 99.73 | 99.98 | 0.62 | 0.48 | 0.51 |
| EXAMPLE 1 | | | | | | |
| COMPARATIVE | 100.25 | 99.94 | 100.03 | 0.31 | 0.22 | 0.49 |
| EXAMPLE 2 | | | | | | |

As apparent from the comparison between the result of the working example 1 and the result of the comparative example 1, an effect of significantly reducing the fluctuation of the application width and the end swelling is recognized in the light extraction substrate according to the working example 1 of the present embodiment.

In the comparative example 1, although the end swelling amount is equal to that in the comparative example 2 in which only the high refractive layer is independently applied, fluctuation in the application width significantly increases. It would appear that the increase in the application width fluctuation is largely influenced by the wettability of the substrate on the ends of the low refractive layer.

However, in the working example 1 having the structure of the present embodiment, by virtue of an effect obtained by the outer fence part 6 which restricts the application width fluctuation, it is possible to obtain an application width accuracy of a degree of patterning of the outer fence part 6.

Further, by virtue of an effect of receiving an excessive volume of the swelling portion by the recess part 5, it is possible to significantly reduce the swelling amount.

As described above, it has been confirmed that a high-quality light extraction substrate can be obtained even by a manufacturing method including an application process using a low-cost material by using the organic EL lighting substrate 40 of the present embodiment.

The above embodiment makes it possible to provide an organic EL lighting which has high light emission efficiency and is capable of achieving frame narrowing by a low-cost manufacturing method by using the light extraction substrate 43 of the organic EL lighting.

Further, the above embodiment has a structure having the feature that the outer fence part 6 is porous, or the surface of the high refractive layer 3 is flat. Further, each of the low refractive layer 2, the recess part 5, and the outer fence part 6 is composed of a photo-curable resin. Such a configuration makes it possible to achieve the light extraction substrate 43 of the organic EL lighting which has high light emission efficiency and is capable of achieving frame narrowing by a low-cost application method.

Further, by properly combining arbitrary embodiment (s) and modification (s) of the aforementioned various embodiments and modifications, the effects owned by each of them can be made effectual.

The light extraction substrate of the organic EL lighting of the present invention makes it possible to achieve cost reduction and frame narrowing in an organic EL lighting panel, and can also be applied with a transparent substrate. Therefore, the light extraction substrate can also be applied to flexible display application which is expected to be developed hereafter.

Although the present invention has been fully described in connection with the preferred embodiments thereof with reference to the accompanying drawings, it is to be noted that various changes arid modifications are apparent to those skilled in the art. Such changes and modifications are to be understood as included within the scope of the present invention as defined by the appended claims unless they depart therefrom.

What is claimed is:

1. A light extraction substrate of an organic EL lighting comprising:
a transparent substrate;
a first layer formed on the substrate, the first layer having a surface including a diffraction grating part having a plurality of fine concavities and convexities;
a second layer formed on the transparent substrate so as to be embedded in the diffraction grating part with no space therebetween;
a recess part having a fixed width, the recess part being formed on an outer periphery of the first layer; and
an outer fence part having a fixed width, the outer fence part being formed on an outer periphery of the recess part,
wherein the second layer is embedded in the recess part.

2. The light extraction substrate according to claim 1, wherein the diffraction grating part, the recess part, and the outer fence part are formed of same material.

3. The light extraction substrate according to claim 1, wherein the diffraction grating part and the outer fence part are divided from each other.

4. The light extraction substrate according to claim 1, wherein the recess part has a quadrilateral frame shape, and a width dimension of the recess part is equal in two sides facing each other and different in two sides perpendicular to each other.

5. The light extraction substrate according to claim 1, wherein a surface of the second layer is flat.

6. The light extraction substrate according to claim 2, wherein a surface of the second layer is flat.

7. The light extraction substrate according to claim 1, wherein each of the diffraction grating part, the recess part, and the outer fence part is made of a photo-curable resin.

8. The light extraction substrate according to any claim 2, wherein each of the diffraction grating part, the recess part, and the outer fence part is made of a photo-curable resin.

9. The light extraction substrate according to claim 3, wherein each of the diffraction grating part, the recess part, and the outer fence part is made of a photo-curable resin.

10. The light extraction substrate according to claim 1, wherein the outer fence part divided from the diffraction grating part is porous.
